(19) United States
(12) Patent Application Publication
(10) Pub. No.: US 2013/0036924 A1
(43) Pub. Date: Feb. 14, 2013

(54) Trashcan

(71) Applicant: Wen-Hsiung Ko, Taichung City (TW)

(72) Inventor: Wen-Hsiung Ko, Taichung City (TW)

(21) Appl. No.: 13/209,106

(22) Filed: Aug. 12, 2011

(51) Int. Cl. B30B 1/00

(52) U.S. Cl. 100/214

(57) ABSTRACT

An improved trashcan includes an outer can having an accommodating space with an upward opening. The top of the outer can is pivotally provided with a controllable upper cover having an opening. The opening is embedded with a stepping board. The bottom of the upper cover has at least one restoring mechanism with several elastic elements for driving the stepping board to move along the axial direction of the accommodating space reciprocally.

### BACKGROUND OF THE INVENTION

1. Field of Invention

The invention relates to a trashcan structure and, in particular, to a trashcan that can compress the volume of trash by stepping.

2. Related Art

A conventional trashcan that can compress trash volume is shown in FIG. 6. The trashcan body consists of an outer can 61, an inner can 62, and a top can 63 mounted in sequence. The top of the outer can 61 is pivotally provided with an upper cover 64. The upper cover 64 has an opening 65 embedded with a stepping board 66. The bottom of the upper cover 64 has a hollow annular base 67. The base 67 has four tracks 68 symmetrically around the base 67. Each of the tracks 68 accommodates a stretching spring 69. One end of each of the stretching springs 69 is fixed to one end of the corresponding track 68. The other end thereof is connected with a rope 70. Each of the ropes 70 extends along the corresponding track 68 and winds around a pulley 71 on the corresponding track 68. The ropes 70 thus redirect to go through the base 67 downward and to connect to the stepping board 66. When the stepping board 66 is stepped by a user to the bottom of the trashcan, the elastic elements 69 can bring the stepping board 66 back to its original position.

However, since the body of the above-mentioned trashcan consists of an outer can 61, an inner can 62, and a top can 63 and the pulley 71 in each of the tracks 68 is fixed to the corresponding track 68 by a pin 72, there are the problem of too many components, time-consuming assembly, and higher production costs.

As shown in FIG. 7, the surrounding of the stepping board 66 in the above-mentioned trashcan structure has four ladder-shaped holes 73 for the ropes to go through. The end of each of the ropes 70 has a fixing element 74. The outer surface of each of the fixing elements 74 is formed with a large-diameter part 741 and a small-diameter part 742 correspondingly accommodated in the corresponding ladder-shaped hole 73. Each of the fixing elements 74 can be accommodated in the corresponding ladder-shaped hole 73 to achieve the purpose of connecting to the stepping board 66. However, since the stepping board 66 is often stepped by users and thus becomes dirty. It needs to be taken off frequently for cleaning and hygiene. Nevertheless, after the stepping board 66 is assembled to the above-mentioned trashcan structure, the fixing elements 74 for connecting to the stepping board 66 are completely accommodated in the ladder-shaped holes 73. The user therefore cannot directly exert a force on the fixing elements 74 for drawing the fixing elements 74 from the ladder-shaped holes 73. Such a disassembly procedure inevitably causes inconvenience and trouble for the user to take off the stepping board 66.

### SUMMARY OF THE INVENTION

An objective of the invention is to provide a trashcan that is simple in structure, easy to assemble, and cheap to manufacture.

Another objective of the invention is to provide a trashcan whose stepping board is easy to take off for cleaning.

To achieve the above-mentioned objectives, the disclosed trashcan includes:

an outer can having an accommodating space with an upward opening;

an inner can whose top and bottom ends are penetrated through, which is accommodated in the accommodating space of the outer can, and which has an action space therein;

an upper cover pivotally installed at the top of the outer can and having a opening at the center thereof; wherein a restoring mechanism is disposed at the bottom of the upper cover, corresponding to each of two opposite sides of the opening; the two restoring mechanisms have a first accommodating recess and a second accommodating recess that are adjacent and in parallel; the two accommodating recesses have a scroll axis on the closer ends; the other ends of the two accommodating recesses that are far from each other are penetrated downward with the corresponding restoring mechanisms and pivotally installed with a pulley, respectively; each of the scroll axes has an elastic element for restoration by scrolling; each of the scroll axes are surrounded by a rope; and the rope on each of the scroll axes extends and winds around the pulley of the corresponding accommodating recess, thereby penetrating downward through the corresponding restoring mechanism; and

a stepping board disposed in the opening of the upper cover and at the bottom of the two restoring mechanisms; wherein the stepping board is connected with the ropes from the two restoring mechanisms and driven to move along the axial direction of the inner can reciprocally.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of the invention;

FIG. 2 is a locally exploded view of the invention;

FIG. 3 is a schematic structural view of the invention after assembly;

FIG. 4 is a schematic view of the invention in use, showing that the upper cover is opened upward relative to the other side of the pivotally connected outer can;

FIG. 5 is a schematic view of the invention in use, showing that the stepping board is compressing trash as a user steps the stepping board downward;

FIG. 6 is a schematic view of a conventional trashcan that can compress trash volume; and

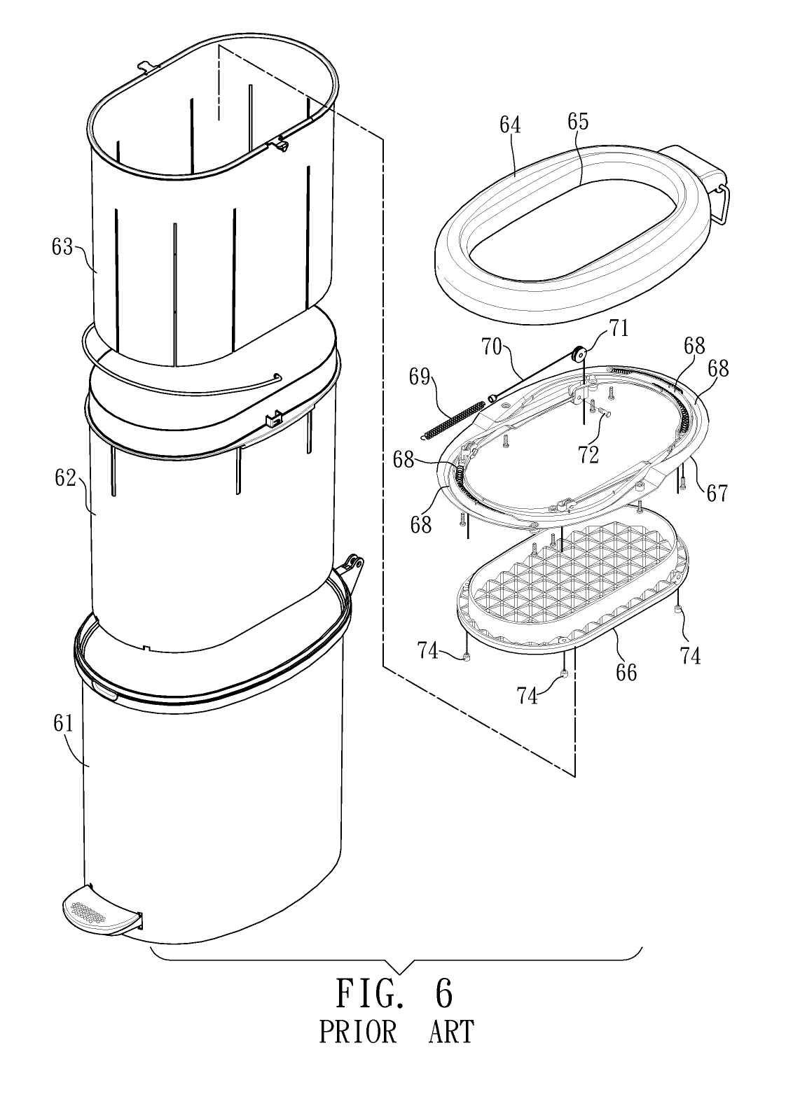

FIG. 7 is a locally exploded view of FIG. 6.

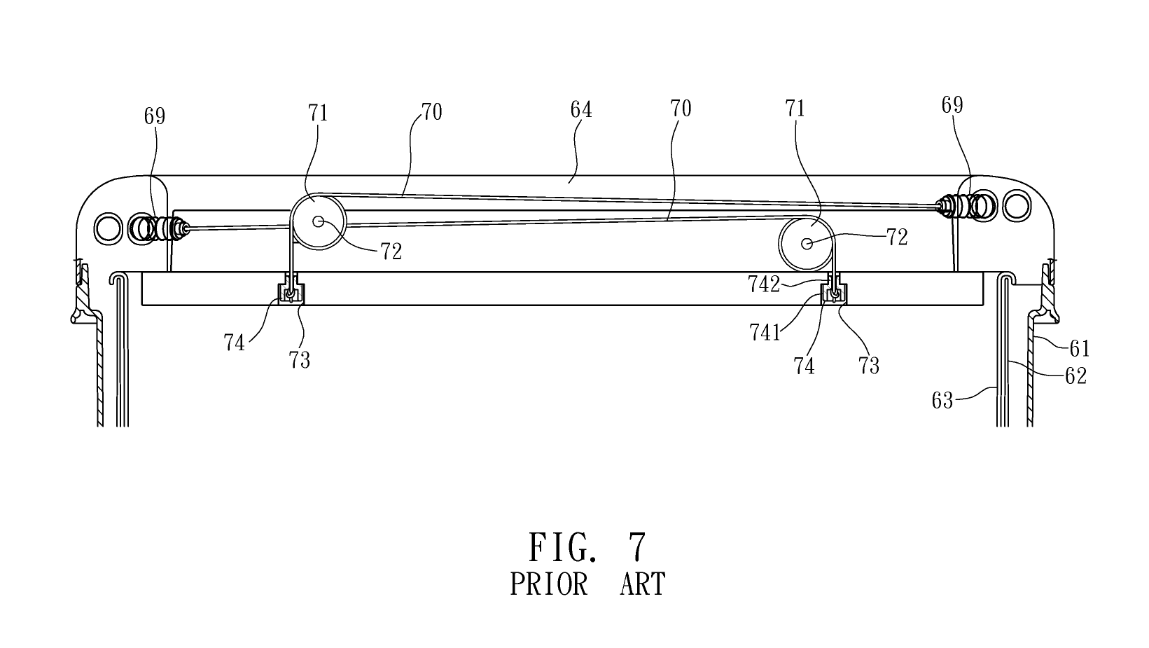

### DETAILED DESCRIPTION OF THE INVENTION

The present invention will be apparent from the following detailed description, which proceeds with reference to the accompanying drawings, wherein the same references relate to the same elements.

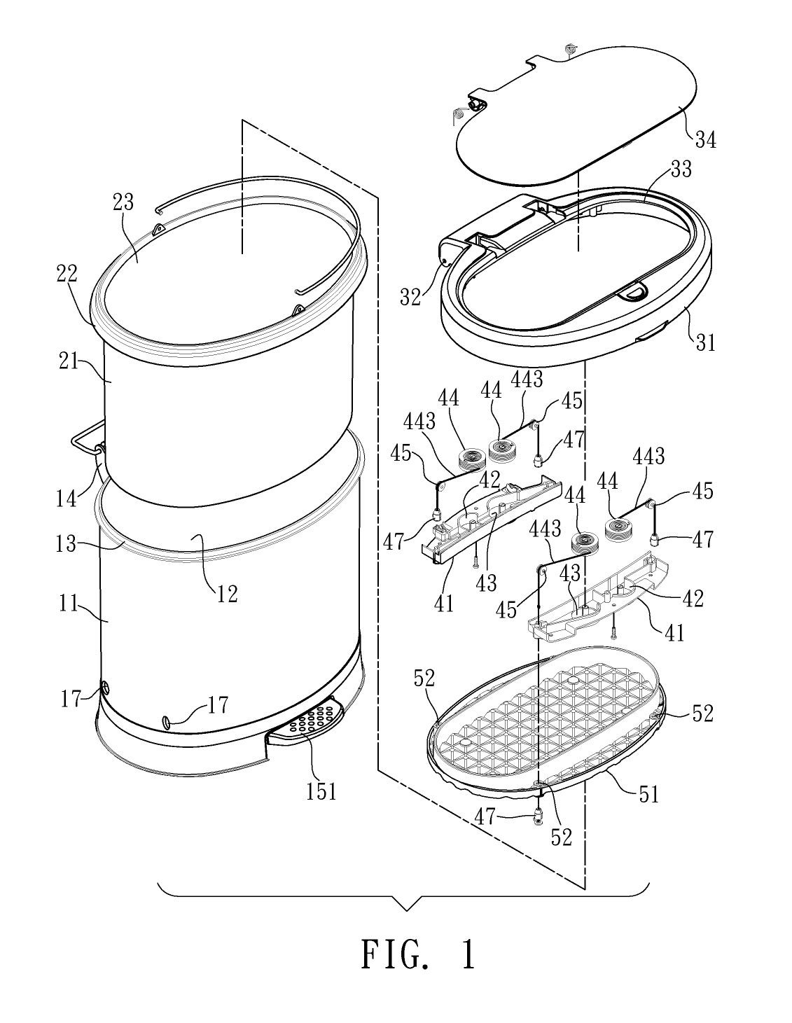

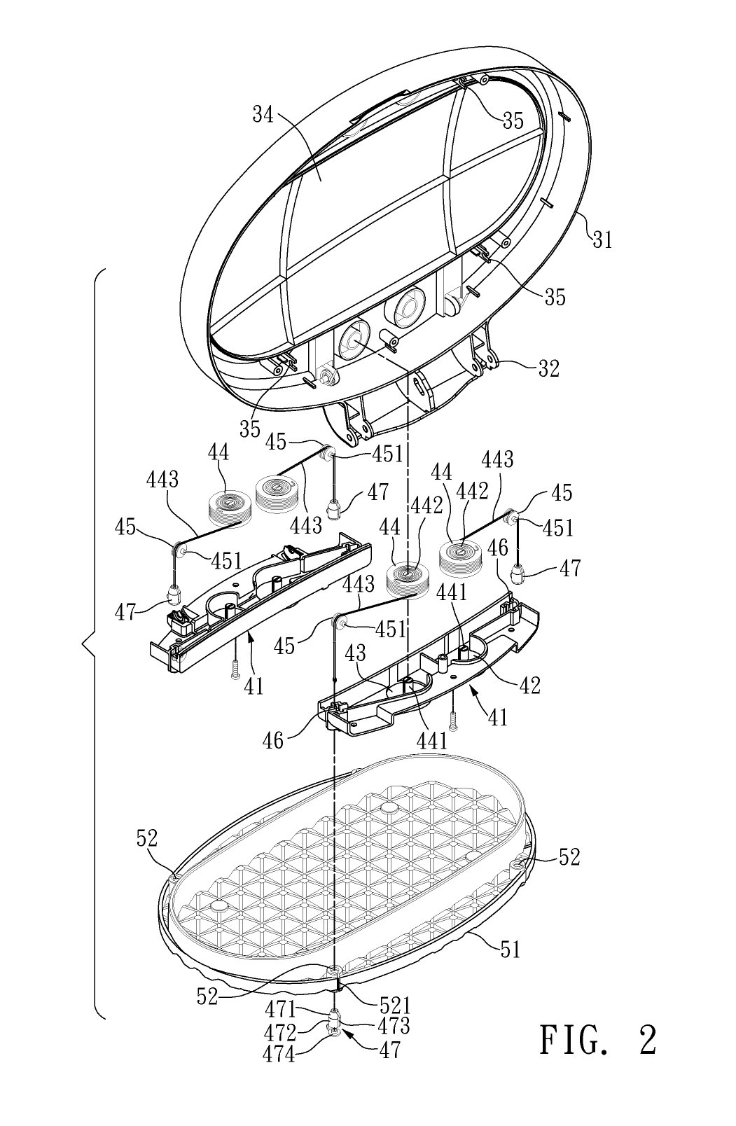

Please refer to FIGS. 1 to 5. The disclosed trashcan structure includes: an outer can 11, an inner can 21, an upper cover 31, and a stepping board 51.

The outer can 11 has an accommodating space 12 with an upward opening for accommodating a trash bag 10. The surrounding of the opening is extended upward with an engaging part 13. The outer can 11 has a first pivotal connecting part 14 on the top and the long-axis side thereof for pivotal connection of the upper cover 31. The bottom of the outer can 11 is pivotally provided with a horizontal stepping bar 15. One end of the stepping bar 15 extends from the bottom of the outer can 11 to the outer side on the other side of the long axis of the outer can 11, thereby connecting a stepping part 151. The other end of the stepping bar 15 connects a connecting bar 16 to the first pivotal connecting part 14 and pivotally connects to one side of the upper cover 31, thereby controlling the upper cover 31 to open pivotally with respect to the other side of the outer can 11. The inner wall of the outer can 11 has several vent holes 17 in communications with the exterior of the outer can 11.

The top and bottom of the inner can 21 are penetrated through. The surrounding of the top of the inner can 21 is extended outward and downward with a hooking part 22 corresponding to the engaging part 13 of the outer can 11. When the inner can 21 is accommodated in the outer can 11, the inner can 21 is fixed by the hooking part 22 and the engaging part 13 at the opening of the trash bag 10. The interior of the inner can 21 is defined with an action space 23. The outer diameter of the inner can 21 is smaller than the inner diameter of the accommodating space 12 of the outer can 11 so that the inner can 21 can be accommodated in the accommodating space 12 of the outer can 11. Moreover, the trash bag 10 in the accommodating space 12 of the outer can 11 is stretched and urged against the inner wall of the outer can 11 by the inner can 21.

The shape of the upper cover 31 matches with that of the outer can 11. The outer diameter of the upper cover 31 is greater than the outer diameter of the outer can 11 for the upper cover 31 to cover the top of the outer can 11. One side of the upper cover 31 has a second pivotal connecting part 32 for pivotal connection with the first pivotal connection part 14 of the outer can 11. The center of the upper cover 31 is formed with an opening 33. The top of the upper cover 31 is further pivotally connected with a cover 34 for sealing the opening 33. A restoring mechanism 41 is disposed at the bottom of the upper cover 31 on each of opposite sides of the opening 33. The two restoring mechanisms 41 have a first accommodating recess and a second accommodating recess 43 that are adjacent and in parallel to each other. The near ends of the first and second accommodating recesses 42, 43 are protruded with a fixing pole 441, respectively, for mounting a scroll axis 44. The other farther away ends of the first and second accommodating recesses 42, 43 are penetrated through downward for pivotal connection of a pulley 45 on the restoring mechanism 41. Each of the scroll axes 44 has an elastic element 442 consisting of a coil spring for driving the corresponding scroll axis 44 to wind and restore position. The surrounding of each of the scroll axes 44 is winded with a rope 443. The rope 443 on each of the scroll axes 44 winds around the pulley 45 of the first or second accommodating recess 42, 43. Each of the pulleys 45 is protruded with a pivotal axis 451 from the center of two opposite end surfaces. The first and second accommodating recesses 42, 43 have a receiving part 46 with a downward notch 461 of a cross shape at the position corresponding to the pulley 45. The positions on the upper cover 31 corresponding to the pulleys 45 are protruded downward with positioning parts 35 for enclosing the pulleys 45, respectively. Therefore, when each of the restoring mechanisms 41 is connected to the bottom of the upper cover 31, the positioning of the pulleys 45 is done concurrently.

The stepping board 51 is a sheet horizontally disposed in the opening 33 of the upper cover 31. It is located at the bottom of the two restoring mechanisms 41 to move reciprocally along the axial direction of the action space 23 of the inner can 21. The surrounding of the stepping board 51 is opened with four through holes 52 corresponding to the notches 461 of the two restoring mechanisms 21. The downward extending ropes 443 of the two restoring mechanisms 41 thus go through the stepping board 51 via the corresponding through holes 52. One side of each of the through holes 52 is formed with a longitudinal groove 521. The corresponding rope 443 is then embedded into the through hole 52 via the longitudinal groove 521. The end of each of the ropes 443 going through the stepping board 51 is connected with a fixing element 47 in the shape of a hollow pipe. The surrounding of each of the fixing elements 47 has a conic small-diameter part 471 and a large-diameter part 472. Each of the fixing elements 47 is inserted into the corresponding through hole 52 with the conic small-diameter part 471. The large-diameter part 472 is exposed from the corresponding through hole 52 to connect to the stepping board 51. The stepping board 51 is thus driven to move reciprocally along the axial direction of the action space 23 in the inner can 21. The side of each of the fixing elements 47 is also formed with a longitudinal groove 473 for the corresponding rope 443 to embed into the corresponding fixing element 47 via the longitudinal groove 473. The bottom of each of the fixing elements 47 has a sealing cover 474 for sealing the end of the corresponding fixing element 47, thereby sealing the end of the rope 443 inside the fixing element 47.

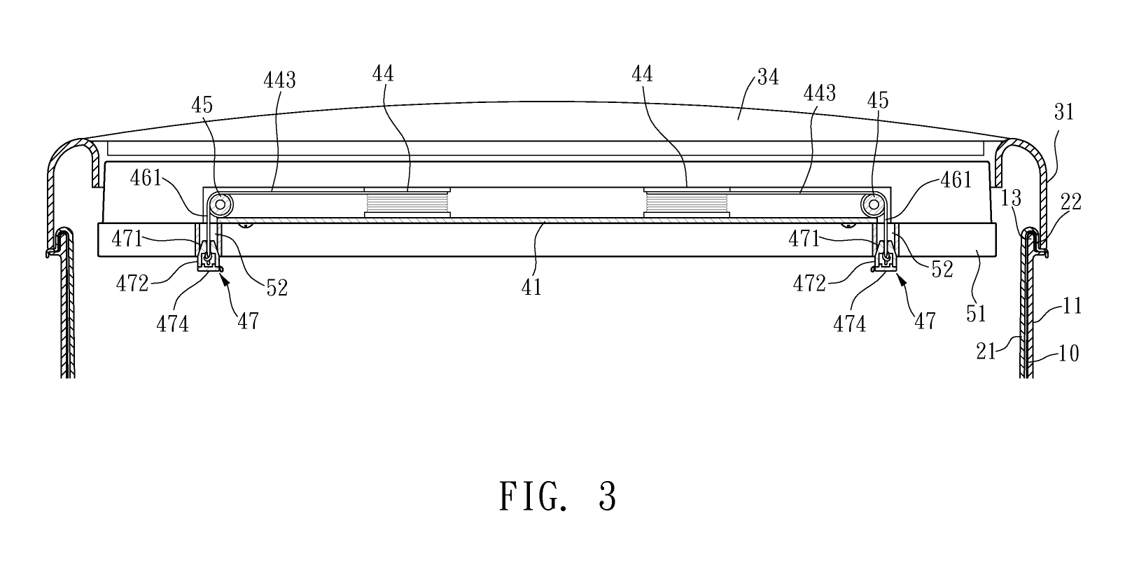

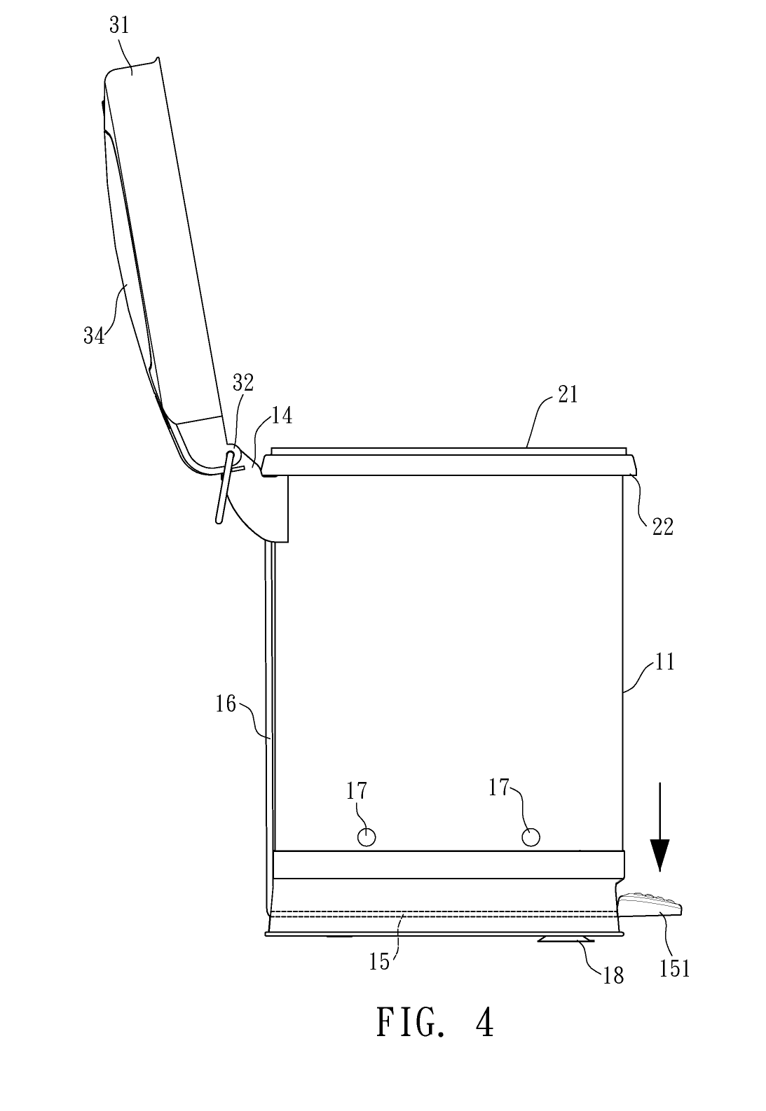

When the invention is in use, as shown in FIG. 3, the trash bag 10 is disposed in the accommodating space 12 of the outer can 11. The inner can 21 is then disposed in the trash bag 10 to push out the trash bag 10. The hooking part 22 of the inner can 21 and the engaging part 13 of the outer can 11 engage with each other to fix the opening of the trash bag 10. Afterwards, the upper cover 31 with the two restoring mechanisms 41 covers the outer can 11 and connects to the stepping board 51. To throw away trash, as shown in FIG. 4, the user can step on the stepping part 151 of the stepping bar 15 on the outer side of the outer can 11. The stepping bar 15 moves the upper cover 31 via the connecting bar 16. The upper cover 31 then opens up on the side opposite to its pivotal connection to the outer can 11. The user can throw trash into the trash bag 10 now. A sucker 18 is provided on an end surface at the bottom of the outer can 11 and opposite to a supporting plane in order to adhere onto the supporting plane. This effectively increases the stability of the trashcan.

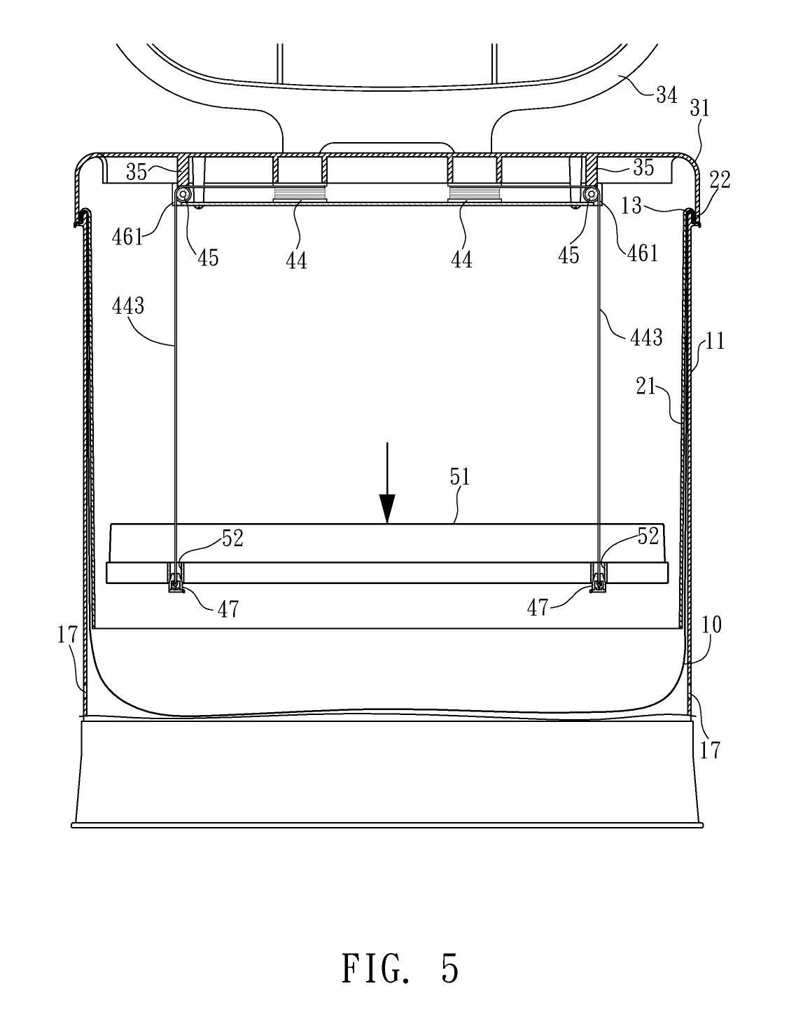

When trash is accumulated to a certain extent, the user can step on the stepping board 51 in the opening 33 of the upper cover 31 to compress the trash volume. As shown in FIG. 5, once the cover 34 is open, the user can step on the stepping board 51 to compress the trash. The trash thus becomes more compact, and the trashcan can accommodate more trash. Once the user stop imposing a force on the stepping board 51, the stepping board 51 is pulled back by the ropes 443 that are under the restoring forces of the restoring mechanisms 41. The stepping board 51 thereby resumes its position at the bottom of the opening 33 of the upper cover 31 for the next compression.

With the above-mentioned structure, the invention has the following advantages:

1. The upper cover 31 is pivotally installed on the long-axis side at the top of the outer can 11. Therefore, when the upper cover 31 flips open, the trashcan is relatively stable. The end surface at the bottom of the outer can 11 is provided with a sucker 18 for adhering onto a supporting plan (as shown in FIG. 4), further reinforcing the stability of the invention. The body of the disclosed trashcan simply consists of an outer can 11 and an inner can 21. This reduces the production cost.

2. The trash bag is disposed in the outer can 11, and the inner can 21 is disposed in the accommodating space 12 of the outer can 11. The inner can 21 urges the surrounding of the trash bag 10 against the inner wall of the outer can 11. This prevents the trash bag from being pierced by trash during the process of compressing trash. Moreover, the outer can 11 is designed with several vent holes 17 so that the trash bag 10 is more flatly urged against the inner wall of the outer can 11 during the compression. Besides, the opening of the trash bag 10 in the outer can 11 can be accommodated in the hooking part 22 at the top of the inner can 21, fixed and positioned by the engaging part 13 of the outer can 11. The opening of the trash bag 10 is thus hidden and unlikely to fall off.

3. The fixing elements at the ends of the ropes 443 that go through the stepping board 51 have a conic small-diameter part 471 and a large-diameter part 472, respectively. Each of the fixing elements 47 is inserted into the corresponding through hole 52 of the stepping board 51 using the conic small-diameter part 471. The large-diameter part 472 is exposed from the corresponding through hole 52. To disassemble the stepping board, the user can simply exert a force on the large-diameter end 472 of the fixing element 47 to quickly release the stepping board 51.

4. The centers of two opposite end surfaces of each of the pulleys 45 are protruded with a pivotal axis 451, respectively. Each of the accommodating recesses 42, 43 has a receiving part 46 with a downward notch 467 in the shape of a cross at the location for installing the corresponding pulley 45. The position on the upper cover 31 corresponding to each of the pulleys 45 is protruded downward with a positioning part 35 that can enclose the corresponding pulley 45. When each of the restoring mechanisms 41 is fixed to the bottom of the upper cover 31, the positioning of each of the pulleys 45 is achieved concurrently. The assembly is thus easier and requires less time. This also has the advantage of reducing the production cost.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A trashcan, comprising:
an outer can having an accommodating space with an upward opening;
an inner can whose top and bottom ends are penetrated through, which is accommodated in the accommodating space of the outer can, and which has an action space therein;
an upper cover pivotally installed at the top of the outer can and having a opening at the center thereof; wherein a restoring mechanism is disposed at the bottom of the upper cover, corresponding to each of two opposite sides of the opening; the two restoring mechanisms have a first accommodating recess and a second accommodating recess that are adjacent and in parallel;
the two accommodating recesses have a scroll axis on the closer ends; the other ends of the two accommodating recesses that are far from each other are penetrated downward with the corresponding restoring mechanisms and pivotally installed with a pulley, respectively; each of the scroll axes has an elastic element for restoration by scrolling; each of the scroll axes are surrounded by a rope; and the rope on each of the scroll axes extends and winds around the pulley of the corresponding accommodating recess, thereby penetrating downward through the corresponding restoring mechanism; and
a stepping board disposed in the opening of the upper cover and at the bottom of the two restoring mechanisms; wherein the stepping board is connected with the ropes from the two restoring mechanisms and driven to move along the axial direction of the inner can reciprocally.

2. The trashcan of claim 1, wherein the a first pivotal connecting part is provided on the side of long axis of the top of the outer can for pivotal connection of the upper cover, and one side of the upper cover has a second pivotal connecting part corresponding to the first pivotal connecting part.

3. The trashcan of claim 2, wherein the bottom of the outer can is pivotally provided with a horizontal stepping bar; one end of the stepping bar extends from the bottom of the outer can to the outside on the other side of the long axis of the outer can, connecting to a stepping part; the other end of the stepping bar connects to the first pivotal connecting part via a connecting bar and pivotally connects to one side of the upper cover, thereby controlling the pivotal opening of the upper cover with respect to the other side of the outer can.

4. The trashcan of claim 1, wherein the inner wall of the outer can is formed with a plurality of vent holes in communications with the exterior of the outer can.

5. The trashcan of claim 1, wherein the end surface at the bottom of the outer can opposite to a supporting plane has a sucker for adhering onto the supporting plane.

6. The trashcan of claim 1, wherein the surrounding of the opening of the outer can is extended upward with an engaging part; the surrounding at the top of the inner can is extended outward and downward with a hooking part corresponding to the engaging part; and when the inner can is disposed in the outer can, the hooking part and the engaging part engage with each other and fix at the opening of the trash bag in the outer can.

7. The trashcan of claim 1, wherein the top of the upper cover is pivotally provided with a cover for sealing the opening.

8. The trashcan of claim 1, wherein the near ends of the first and second accommodating recesses are protruded with fixing pole for mounting the scroll axes, and each of the scroll axes has an elastic element consisting of a coil spring for the corresponding scroll axis to wind and restore position.

9. The trashcan of claim 1, wherein the centers of the two opposite end surfaces of each of the pulleys are protruded with a pivotal axis, respectively; each of the accommodating recesses has a receiving part with a downward notch in the shape of a cross at the locations for the installation of the pulleys, respectively; and the upper cover is protruded downward with a positioning part at the location corresponding to each of the pulleys for enclosing the surrounding of the corresponding pulley.

10. The trashcan of claim 9, wherein the surrounding of the stepping board is formed with four through holes corresponding to the notches of the two restoring mechanisms for the downward extending ropes of the two restoring mechanisms to go through the stepping board via the corresponding through holes; the end of each of the ropes going through the stepping board is further connected with a fixing element in the shape of a hollow pipe; the surrounding of each of the fixing elements has a conic small-diameter part and a large-diameter part; and each of the fixing elements is inserted into the corresponding through hole using the conic small-diameter part, whereas the large-diameter part is exposed from the through hole to connect to the stepping board.

11. The trashcan of claim 10, wherein one side of each of the through holes is formed with a longitudinal groove for the corresponding rope to be embedded in the corresponding through hole.

12. The trashcan of claim 10, wherein the side of each of the fixing element is formed with a longitudinal groove for the corresponding rope to be embedded in the corresponding fixing element via the longitudinal groove.

13. The trashcan of claim 11, wherein the bottom of each of the fixing elements has a sealing cover for sealing the end of the corresponding fixing element, thereby sealing the end of the corresponding rope inside the fixing element.
